(19) United States
(12) Patent Application Publication
(10) Pub. No.: US 2017/0086552 A1
(43) Pub. Date: Mar. 30, 2017

(54) CONTACT LENS PACKAGING AND PACKAGING METHODS

(71) Applicant: Peter MICHALOS, Southampton, NY (US)

(72) Inventor: Peter MICHALOS, Southampton, NY (US)

(21) Appl. No.: 14/867,076

(22) Filed: Sep. 28, 2015

(51) Int. Cl. A45C 11/00; G02C 7/04

(52) U.S. Cl. CPC A45C 11/005; G02C 7/04

(57) ABSTRACT

A packaging for a disposable contact lens includes a structure that engages the contact lens within an interior of the packaging.

### BACKGROUND OF THE INVENTION

Field of the Invention

This invention relates generally to contact lenses, and in particular to packaging for contact lens.

Description of Related Art

Disposable contact lenses are formed of silicone hydrogel materials. Preferably, these types of lens are kept hydrated and in curved form, so that they are immediately ready for use when removed from the packaging.

### SUMMARY OF THE INVENTION

According to an aspect of the present invention, there is a contact lens packaging including a solution container defining an interior with a convex shape, and an exterior with a concave shape corresponding to the convex shape. A contact lens defines a concave shape on the convex shape of the solution container. A lid member is configured to cover an opening portion of the solution container, the lid member defining a flat shape opposing the convex shape of the solution container.

### BRIEF DESCRIPTION OF THE DRAWINGS

References are made, in the following text, to the accompanying drawings, in which:

FIG. 1 is a side view of a contact lens packaging in accordance with an exemplary embodiment of the present invention.

FIG. 2 is a bottom view of the exemplary contact lens packaging.

FIG. 3 is a top view of the exemplary contact lens packaging.

FIG. 4 is a section view taken along the line A-A of FIG. 3.

FIG. 5 is a side view showing a cover in the process of being removed from the exemplary contact lens packaging.

FIG. 6 is a side view of a contact lens packaging in accordance with a second exemplary embodiment of the present invention.

FIG. 7 is a bottom view of the second exemplary contact lens packaging.

FIG. 8 is a top view of the second exemplary contact lens packaging.

FIG. 9 is a section view taken along the line A-A of FIG. 8.

The accompanying drawings which are incorporated in and which constitute a part of this specification, illustrate embodiments of the invention and, together with the description, explain the principles of the invention, and additional advantages thereof. Certain drawings are not necessarily to scale, and certain features may be shown larger than relative actual size to facilitate a more clear description of those features. Throughout the drawings, corresponding elements are labeled with corresponding reference numbers.

### DETAILED DESCRIPTION OF EXEMPLARY EMBODIMENTS

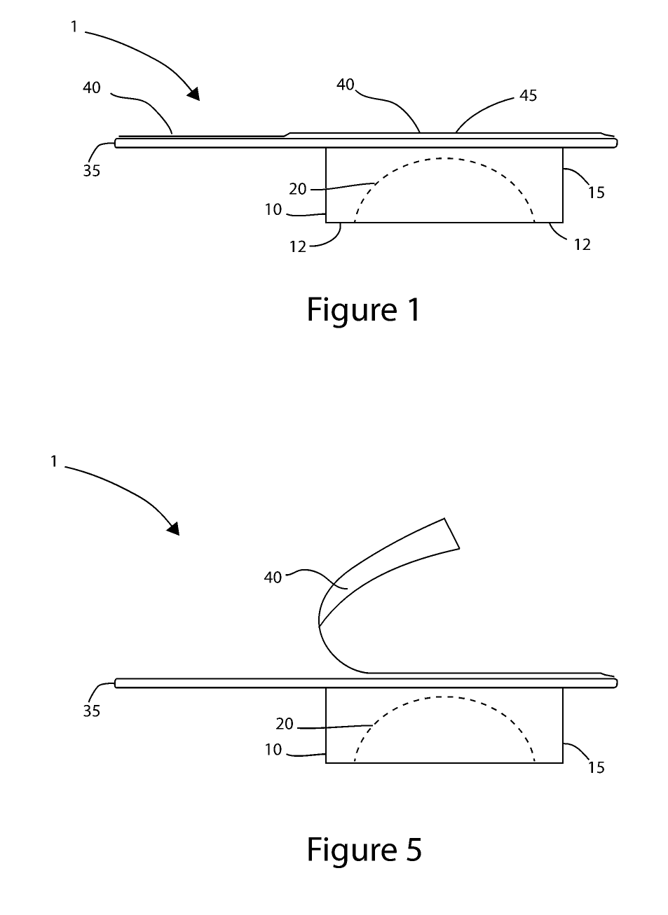

FIG. 1 shows a side view of contact lens packaging 1. A container 10 defines sidewalls 15 and a bottom 12. A convex structure 20 is in an interior of the container 10.

A flat handle 35 is integrally formed with the container 10, in a common factory mold. The flat handle 35 and the container 10 are composed of plastic, such as a material selected from a group consisting of polypropylene, polyethylene, polyethylene telephthalate, polycarbonate, polystyrene and copolymers thereof, or acrylonitrile butadiene styrene copolymer resin.

An aluminum cover 40 is over the handle 35. The aluminum cover 40 defines a flat part 42 that opposes the entirety of the convex structure 20.

The handle 35 is configured to facilitate a fingertip, fingernail, thumbnail or the like gripping and exerting a force to peel off the aluminum cover 40 from the handle 35 to allow access to a contact lens inside.

The metallic foil cover 40 is applied to the top of the handle 35 and the container 10 so that any lens and aqueous liquid contained in the container 10 will remain sterile.

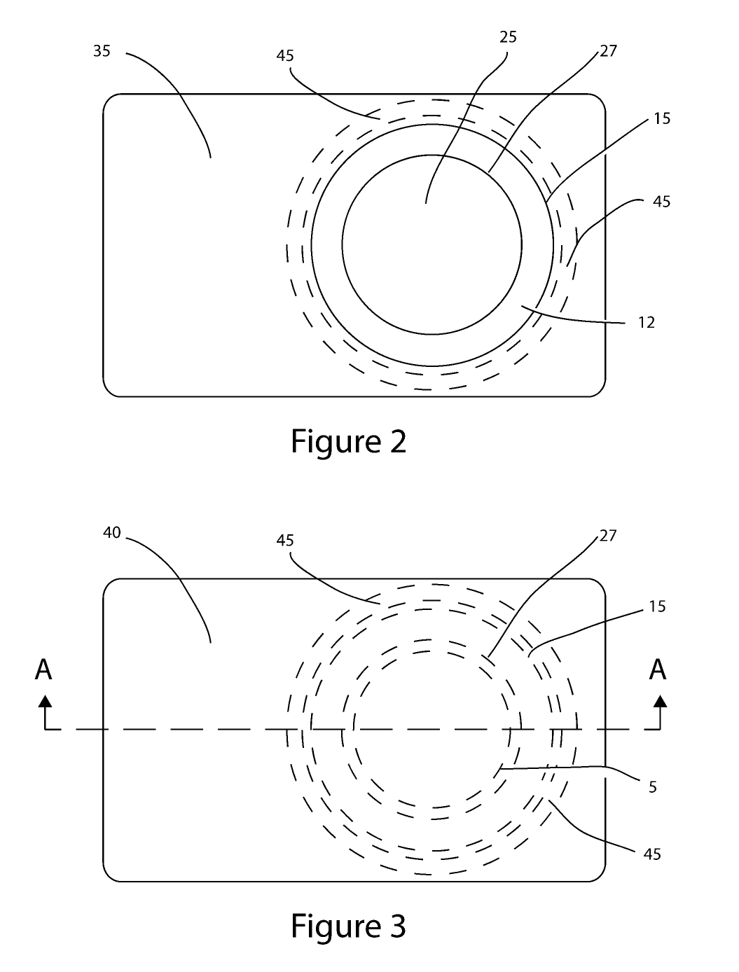

FIG. 2 is a bottom view of the exemplary contact lens packaging 1. As shown in the phantom lines, an annular ring of adhesive binds the aluminum cover 40 to the handle 35. The adhesive ring 45 is a peripheral circumferential portion that surrounds the container 10.

From the exterior perspective of FIG. 2, a concave structure 25 is surrounded by a rim 27 delineating a boundary between the concave structure 25 and the bottom 12 of the packaging 1.

FIG. 3 is a top view of the exemplary contact lens packaging 1.

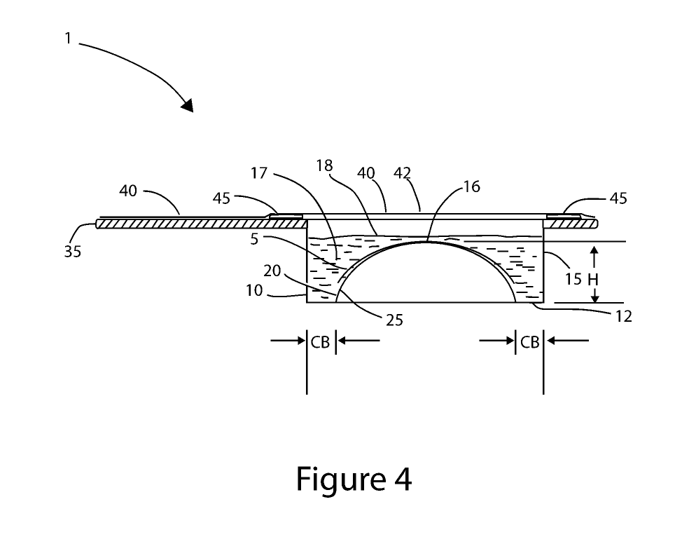

FIG. 4 shows a section view of the packaging 1 taken along the line A-A of FIG. 3. The container 10 defines sidewalls 15, a bottom 12, and a convex structure 20 in an interior of the container 10. The concave structure 25 defined by the exterior of the container 10 mirrors the convex structure 20 in the interior of container 10.

The aluminum cover 40 defines a flat part 42 that opposes the entirety of the convex structure 20.

A sterile aqueous liquid 17, such as a saline solution, is hermetically sealed inside the container 10. When the packaging line 1 is oriented such that the bottom 12 is the lowest part, a surface 18 of the sterile liquid 17 is over the top of convex structure 16.

The packaging line includes a silicone hydrogel contact lens 5. A radius of curvature of the contact lens 5, when the contact lens 5 is oriented with the eye contacting part is concave, is greater than a radius of curvature of the convex structure 20. Thus, when the packaging line 1 is oriented such that the bottom 12 is the lowest part, there is less clearance between the contact lens 5 and the convex structure 20 at the top of convex structure 20, than the clearance between the rim of contact lens 5 and the convex structure 20.

Thus, a cavity, containing the liquid 17 and the contact lens, is defined by the sidewalls 15, the bottom 12, the convex structure 20, and the flat part 42 of the aluminum cover 40.

A dimension CB between the rim of the convex structure 20 and the side wall 15 is in the range 0 to 3 millimeters.

The annular adhesive ring 45 creates a substantially air tight seal between the container 10 and the cover 40 so that, once the package and the contact lens 5 contained therein have been sterilised (e.g. by autoclaving or UV irradiation), the contact lens 5 can remain sterile for prolonged periods (e.g. well over 12 months).

A curvature radius of the convex structure 20 is smaller than a curvature radius of the contact lens 5. In other words, the base curve of convex structure 20 is smaller than the base curve of the contact lens 5.

The base curve of convex structure 20 is in the range 8 to 10 mm.

The diameter of the rim 27 of the convex structure 20 is greater than the diameter of the rim of contact lens 5.

The diameter of the rim 27 of the rim 27 convex structure 20 is up to 15 mm.

FIG. 5 is a side view showing the cover 40 in the process of being removed, thereafter allowing a user place a thumb and forefinger onto the contact lens 5, and remove the contact lens 5 by pressing the contact lens 5 against the convex structure 20.

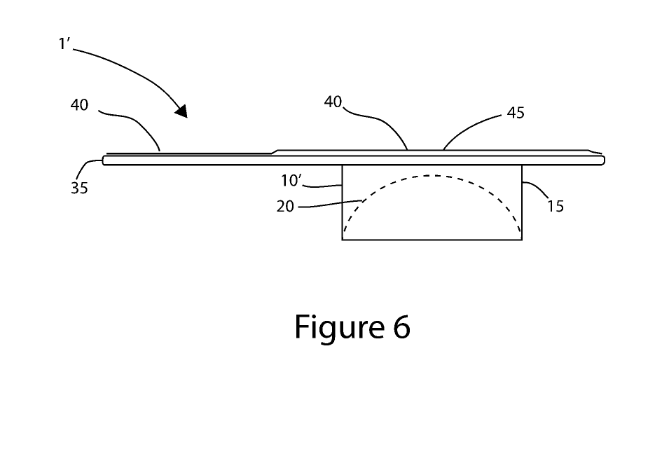

FIG. 6 shows a side view of contact lens packaging 1′, in accordance with a second exemplary embodiment. A container 10′ defines sidewalls 15. A convex structure 20 is in an interior of the container 10.

A flat handle 35 is integrally formed with the container 10′, in a common factory mold.

An aluminum cover 40 is over the handle 35. The aluminum cover 40 defines a flat part 42 that opposes the entirety of the convex structure 20.

The metallic foil cover 40 is applied to the top of the handle 35 and the container 10′ so that any lens and aqueous liquid contained in the container 10 will remain sterile.

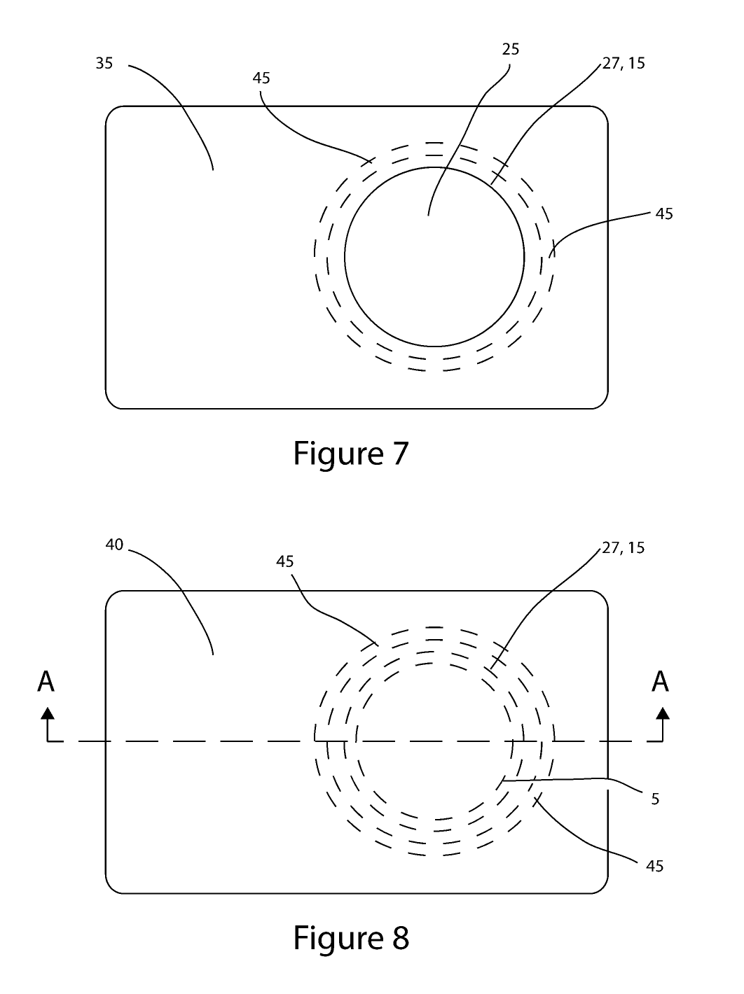

FIG. 7 is a bottom view of the exemplary contact lens packaging 1′. As shown in the phantom lines, an annular ring of adhesive binds the aluminum cover 40 to the handle 35. The adhesive ring 45 is a peripheral circumferential portion that surrounds the container 10′.

From the exterior perspective of FIG. 7, a concave structure 25 is surrounded by a rim 27 delineating a boundary between the concave structure 25 and the sidewall 15 of the packaging 1.

FIG. 8 is a top view of the exemplary contact lens packaging 1′.

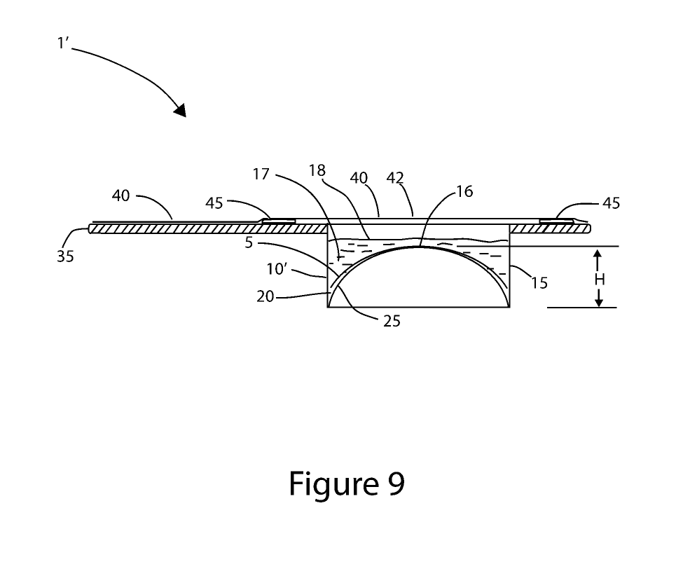

FIG. 9 shows a section view of the packaging 1 taken along the line A-A of FIG. 8. The container 10′ defines sidewalls 15, and a convex structure 20 in an interior of the container 10′. The concave structure 25 defined by the exterior of the container 10′ mirrors the convex structure 20 in the interior of container 10.

The aluminum cover 40 defines a flat part 42 that opposes the entirety of the convex structure 20.

A sterile aqueous liquid 17, such as a saline solution, is hermetically sealed inside the container 10′. When the packaging line 1 is oriented such that the rim 27 is the lowest part, a surface 18 of the sterile liquid 17 is over the top of convex structure 16.

The packaging line includes a silicone hydrogel contact lens 5. A radius of curvature of the contact lens 5, when the contact lens 5 is oriented with the eye contacting part is concave, is greater than a radius of curvature of the convex structure 20. Thus, when the packaging line 1 is oriented such that the bottom 12 is the lowest part, there is less clearance between the contact lens 5 and the convex structure 20 at the top of convex structure 20, than the clearance between the rim of contact lens 5 and the convex structure 20.

Thus, a cavity, containing the liquid 17 and the contact lens, is defined by the sidewalls 15, the convex structure 20, and the flat part 42 of the aluminum cover 40.

A dimension between the rim 27 of the convex structure 20 and the side wall 15 is 0 mm. In other words, the rim of the convex structure 20 is flush against (contiguous with) the side wall 15.

Additional advantages and modifications will readily occur to those skilled in the art. The invention in its broader aspects is therefore not limited to the specific details, representative apparatus, and illustrative examples shown and described. Accordingly, departures may be made from such details without departing from the spirit or the scope of Applicants' general inventive concept. The invention is defined in the following claims. In general, the words “first,” “second,” etc., employed in the claims do not necessarily denote an order.

What is claimed is:

1. A contact lens packaging comprising:
a solution container defining an interior with a convex shape, and an exterior with a concave shape corresponding to the convex shape;
a contact lens defining a concave shape on the convex shape of the solution container; and
a lid member configured to cover an opening portion of the solution container, the lid member defining a flat shape opposing the convex shape of the solution container.

2. The contact lens packaging according to claim 1 further including adhesive attaching the lid member to the solution container.

3. The contact lens packaging according to claim 1 wherein a curvature radius of the convex shape is smaller than a curvature radius of the contact lens.

4. The contact lens packaging according to claim 1 wherein a diameter of a rim of the convex shape is larger than a diameter of a rim of the contact lens.

5. The contact lens packaging according to claim 1 wherein a curvature radius of the convex shape is smaller than a curvature radius of the contact lens, and a diameter of a rim of the convex shape is larger than a diameter of a rim of the contact lens.
